(19) United States
(12) Patent Application Publication
(10) Pub. No.: US 2018/0343051 A1
(43) Pub. Date: Nov. 29, 2018

(54) Communication System Of An Aircraft

(71) Applicant: Airbus Operations S.A.S., Toulouse (FR)

(72) Inventors: Philippe Bramoulle, Muret (FR); Didier Martinez, Figarol (FR)

(73) Assignee: Airbus Operations S.A.S., Toulouse (FR)

(21) Appl. No.: 15/979,846

(22) Filed: May 15, 2018

(30) Foreign Application Priority Data
May 29, 2017 (FR) 17 54686

(51) Int. Cl. H04B 7/185; H04B 1/3822; H04B 1/3827

(52) U.S. Cl. CPC H04B 7/18506; H04B 2001/3866; H04B 1/385; H04B 1/3822

(57) ABSTRACT

The communication system of an aircraft includes a set of communication channels, a communication computer, an audio device and a control device connected to the communication computer. It also includes a wireless communication unit interfaced to the communication computer and configured for simultaneously implementing: a two-way wireless audio link between the wireless communication unit and the audio device, so as to allow an audio communication on one of the communication channels by the audio device, and a two-way wireless data link between the wireless communication unit and the control device, allowing the control device to control the communication computer.

### FIELD OF THE INVENTION

The present invention relates to the field of audio communications on board an aircraft.

### BACKGROUND OF THE INVENTION

For implementing audio communications, modern aircraft comprise a communication system. FIG. 2 illustrates an example of a conventional communication system 10 of an aircraft such as the aircraft 1 represented in FIG. 1. In the context of the present invention, communication system is understood to mean a set of conventional communication equipment, making it possible to implement and monitor the audio communications on board the aircraft. These audio communications are, in particular, all those that the crew members, in particular the pilots, of the aircraft may have by means of a set of communication channels 14. This set of communication channels notably includes one or more VHF channels and/or one or more HF channels for communications with air traffic control. It also includes one or more telephone link channels (labelled “Tel” in the figure), e.g. on the “SATCOM” network, allowing communications with the airline companies. The set of communication channels also includes a channel corresponding to a cabin intercom 16, allowing communications with the crew in the passenger cabin of the aircraft (labelled “Cab” in the figure), etc.

The communication system comprises a communication computer 12 connected to the set of communication channels 14, an audio device and at least one control device 20. The communication computer 12 is generally located in an avionics bay 2 of the aircraft. The audio device and the control device 20 are located in the cockpit 3 of the aircraft where they may be used by a crew member. The communication computer 12 corresponds, for example, to an AMU (“Audio Management Unit”) type unit. The audio device generally includes a microphone 22a and earphones or loudspeakers 22b, all of which may be incorporated in a headset. The microphone 22a and the earphones or loudspeakers 22b are respectively connected to the communication computer via wired links 24a and 24b. The control device 20 generally includes a conventional ACP (“Audio Control Panel”) type device connected to the communication computer 12 via a wired link 21 such as, for example, a communication bus compliant with the ARINC 429 standard. This ACP type device allows the mixing of multiple communication channels in reception: radio communication (VHF, HF, etc.), SATCOM telephone link, cabin intercom, etc. This mixing allows the pilots to listen to multiple channels simultaneously, with the possibility of setting the sound volume of each of said channels by means of buttons for setting the sound volume of the ACP type device. The ACP device further allows a user, such as a pilot, to select a communication channel in transmission (a single channel at a time).

In addition to the ACP type device, the communication system generally includes a second control device, of the RMP (“Radio Management Panel”) type, RCP (“Radio Control Panel”) type or RTP (“Radio Tuning Panel”) type, for setting the radio frequencies of the VHF and HF radio communication channels. It also makes it possible to select or manually set telephone numbers, via the SATCOM system, for example, generally from a page that it can display on an MCDU (“Multipurpose Control and Display Unit”) type device.

Document FR2.821.468A1 describes a control device of a communication system in which the functionalities of an ACP type device, an RMP (or RCP or RTP) type device are incorporated, together with selecting or setting telephone numbers.

A communication system 10 such as that mentioned earlier allows crew members to communicate and manage communications from the cockpit of the aircraft. However, in special circumstances, it may be necessary to manage communications from a location other than the cockpit of the aircraft. For example, during flight tests of the aircraft, it may be useful for a member of an in-flight test team to be able to communicate from the passenger cabin, while managing the different communication channels (choosing the communication channel, etc.). During some flight phases, it may also be useful for a pilot to move about outside the cockpit while retaining the possibility of communicating and managing the communication channels.

### SUMMARY OF THE INVENTION

Aspects of the present invention may provide a solution to these issues. The present invention relates to a communication system of an aircraft, the communication system including a set of communication channels, a communication computer, an audio device and a control device connected to the communication computer.

The communication system is remarkable in that it comprises a wireless communication unit interfaced to the communication computer, this wireless communication unit being configured for simultaneously implementing:
a two-way wireless audio link between the wireless communication unit and the audio device, so as to allow an audio communication on one of the communication channels by means of the audio device, and
a two-way wireless data link between the wireless communication unit and the control device, allowing the control device to control the communication computer.

Thus, the control device and the audio device are connected to the communication computer by wireless links, which allows them to be moved about in the aircraft. Consequently, the user may move about in the aircraft while using the audio device, as well as the control device for managing the communication channels.

Advantageously, the audio device and the control device are incorporated in a portable device and the wireless audio link and the wireless data link are supported by a single wireless link between the wireless communication unit and the portable device. According to one alternative, the single wireless link is of the DECT (“Digital Enhanced Cordless Telecommunications”) type. According to another alternative, the single wireless link is of the WAIC (“Wireless Avionics Intra Communications”) type.

In one embodiment, the wireless communication unit is incorporated into the communication computer.

In particular, the communication computer comprises a wireless communication interface and the wireless communication unit is connected to the communication computer via a single wireless link supporting a two-way wireless audio link and a two-way wireless data link. Advantageously, the wireless communication unit implements the wireless link between the communication computer and said wireless communication unit, and the wireless link between the portable device and said wireless communication unit by means of the same wireless communication interface. In particular, the wireless communication unit is located in the passenger cabin of the aircraft.

In a particular embodiment, the communication system further comprises a second control device connected to the communication computer via a wired link.

The invention also relates to an aircraft comprising a communication system such as that mentioned earlier.

### BRIEF DESCRIPTION OF THE FIGURES

The invention will be better understood on reading the following description and studying the appended figures.

FIG. 1, already described, represents an aircraft comprising a communication system.

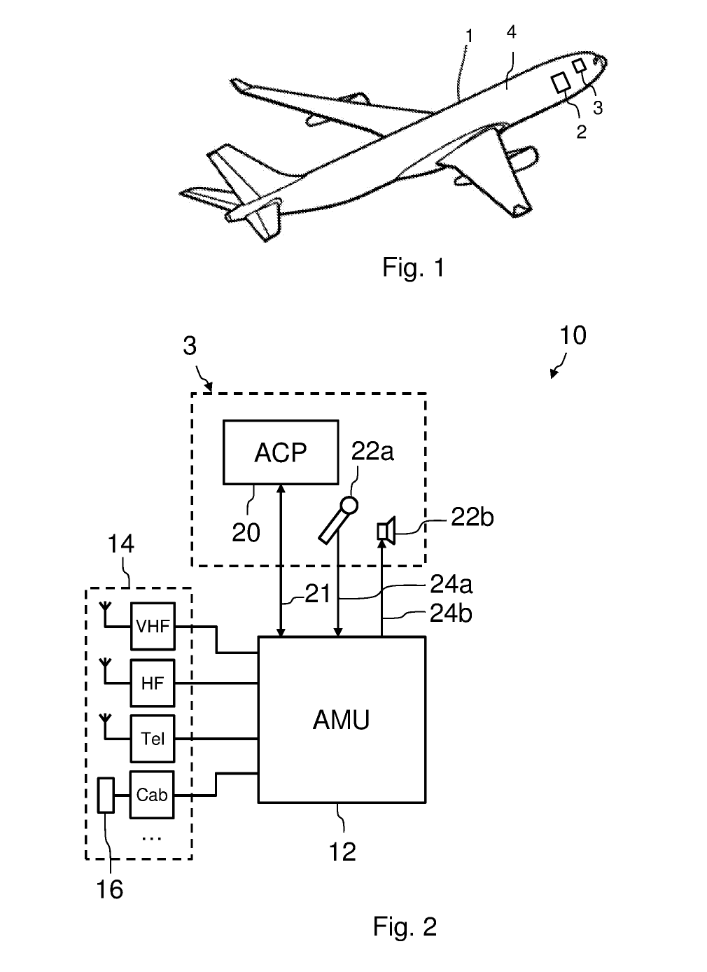

FIG. 2, already described, represents a communication system of the prior art.

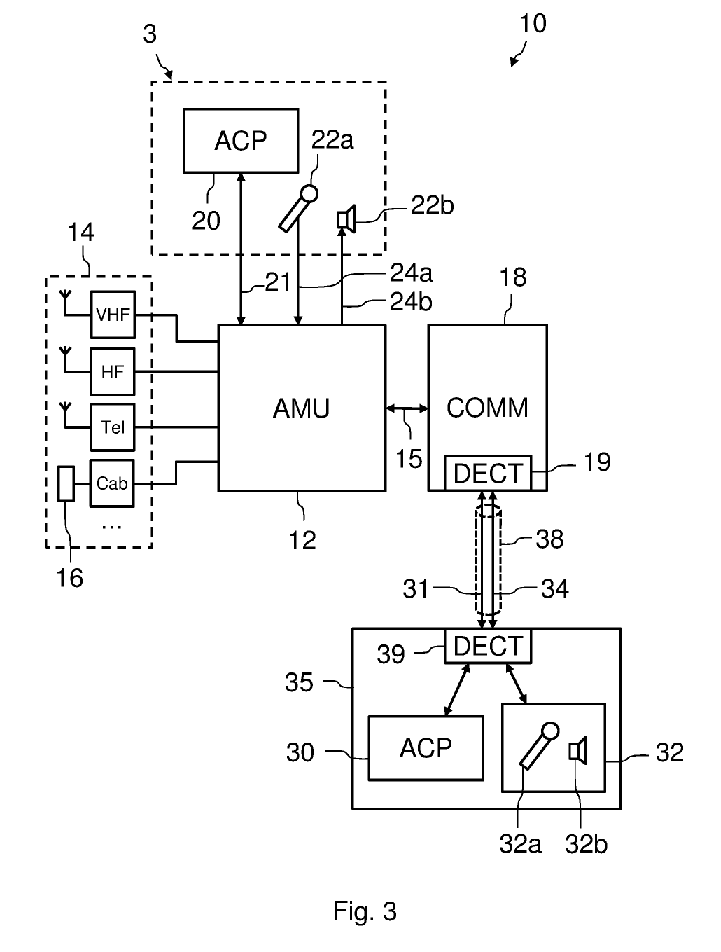

FIG. 3 schematically illustrates a communication system of an aircraft compliant with an embodiment of the invention.

FIGS. 4 and 5 schematically illustrate a communication system of an aircraft compliant with other embodiments of the invention.

FIG. 6 represents an aircraft comprising a communication system compliant with an embodiment of the invention.

### DETAILED DESCRIPTION

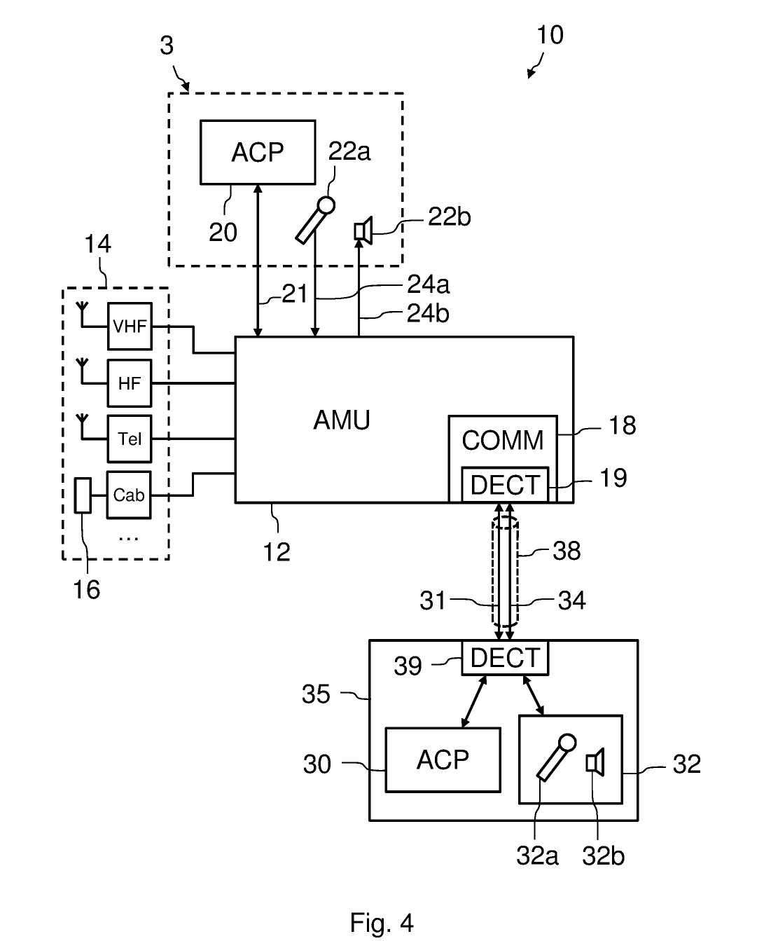

The communication system 10 represented in FIG. 3 comprises a communication computer 12, e.g. of the AMU type, connected to a set of communication channels 14. It also comprises a wireless communication unit 18, labelled COMM in the figure, connected to the communication computer 12 via a link 15. The communication unit 18 comprises a wireless communication interface 19. The communication system further comprises at least one communication terminal 35. The communication terminal 35 advantageously corresponds to a portable device. This communication terminal 35 comprises an audio device 32, a control device 30 and a wireless link interface 39 capable of communicating with the wireless link interface 19 of the communication unit 18. The audio device 32 comprises, for example, a microphone 32a and an earphone or a loudspeaker 32b. In particular, the microphone 32a and the earphone or the loudspeaker 32b are incorporated in a headset. The control device 30 comprises a display and setting buttons and it implements at least one part of the functionalities of a conventional ACP type device. In particular, the display is of the touch screen type and the setting buttons correspond to areas of the touch screen. The communication terminal 35 is connected to the communication unit 18 via a wireless link 38. This wireless link 38 is a single wireless link supporting both a two-way wireless audio connection 34 and a two-way wireless data link 31. The two-way wireless audio link 34 corresponds to an audio link between the wireless communication unit 18 and the audio device 32 of the communication terminal 35, allowing an audio communication on one or more of the communication channels 14 by means of the audio device 32. The two-way wireless data link 31 corresponds to a data link between the wireless communication unit 18 and the control device 30 of the communication terminal 35, allowing the control device to control the communication computer 12. The wireless link 38 implements DECT technology, for example. The communication interfaces 19 and 39 are then DECT type interfaces. This technology offers the advantage of allowing high levels of reliability and availability of communications. In addition, it allows simultaneous communications on multiple communication channels and each communication channel can support both a two-way audio link and a two-way data link.

In operation, a user of the communication terminal 35 selects the channels from the set of communication channels 14 that they wish to listen to, using for this the setting buttons of the control device 30 incorporated in the communication terminal 35. Similarly, if they wish to communicate in transmission, they select the communication channel on which they wish to transmit. The control device 30 then communicates with the communication computer 12, via the data link 31 and the communication unit 18, so as to transmit, to the communication computer 12, the channel selections made by the user thanks to the setting buttons. The communication computer 12 then establishes communications between the desired communication channels and the audio device 32, via the communication unit 18 and the audio link 34. The user of the communication terminal 35 thus benefits from the same functionalities as a pilot using an audio device and an ACP control device in the cockpit 3 of the aircraft. Insofar as the communication terminal 35 is portable, the user may communicate on the audio communication channels and benefit from said functionalities while moving about.

According to one embodiment, the link 15 between the communication computer 12 and the communication unit 18 is a link compliant with the ARINC 429 standard or the ARINC 664 standard Part 7, or even an Ethernet type link. According to another embodiment, this link is a specific link: e.g. the communication computer 12 and the communication unit 18 are incorporated in the same electronics rack and the link 15 uses a backplane of the electronic rack. The communication unit 18 comprises a processing unit such as a microprocessor or a microcontroller. This processing unit is programmed for acting as a gateway between, on one hand, the link 15 with the communication computer 12 and, on the other hand, the wireless communication interface 19.

In an advantageous embodiment, the control device 30 of the communication terminal 35 is configured for implementing functionalities of a conventional device of the RMP, RCP or RTP type. This notably enables the user to select a radio frequency of a communication channel, e.g. of the HF or VHF type or to select a telephone number of a SATCOM type communication link.

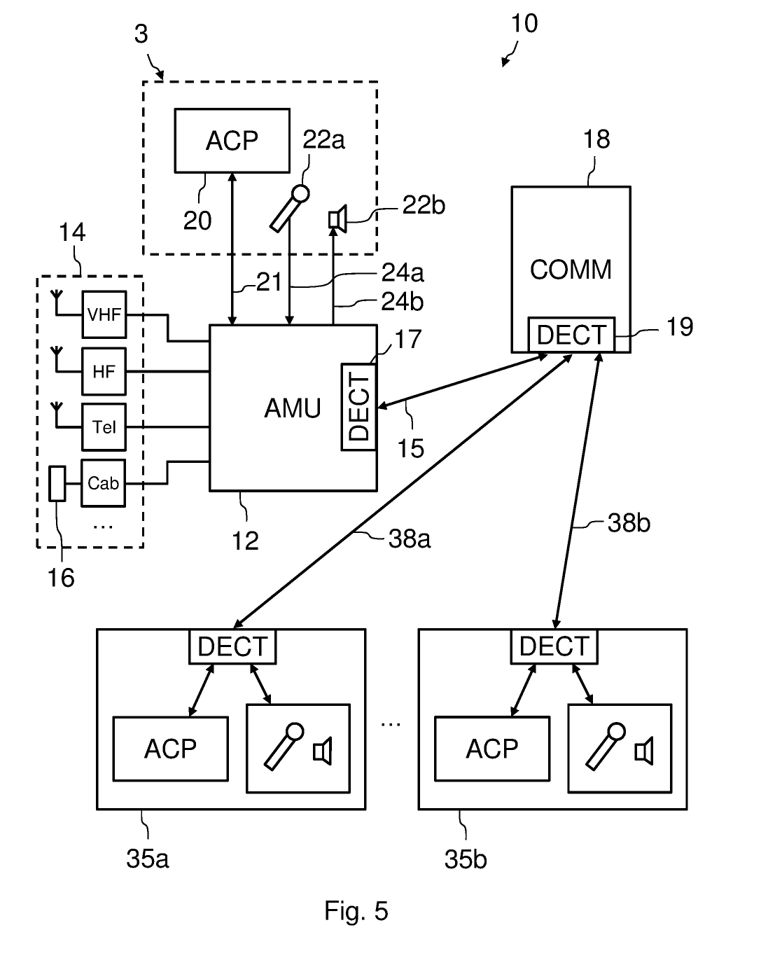

In a particular embodiment represented in FIG. 4, the communication unit 18 is incorporated in the communication computer 12. The processing unit of the communication unit 18 then corresponds to a processing unit of the communication computer 12. The communication computer 12 then comprises the wireless communication interface 19.

In another embodiment represented in FIG. 5, the communication computer 12 also comprises a wireless communication interface 17. The link 15 then corresponds to a wireless link between the wireless communication interface 17 of the communication computer 12 and the wireless communication interface 19 of the communication unit 18. The wireless link 15 is a single wireless link supporting a two-way wireless audio link and a two-way wireless data link. The wireless communication interface 17 is of the same type as the wireless communication interface 19 of the communication unit 18, e.g. of the DECT type. Thus, the wireless communication interface 19 of the communication unit 18 is used both for the link 15 with the communication computer 12, on a first DECT communication channel, and for the link 38 with the communication terminal 35, on a second communication channel. In particular, as represented in FIG. 5, the communication unit 18 may communicate with multiple communication terminals 35a, 35b, etc. by means of multiple wireless links 38a, 38b, etc. similar to the wireless link 38. The different wireless links 38a, 38b, etc. between the communication unit 18 and the different communication terminals 35a, 35b, etc. use different DECT communication channels. Thus, multiple users may communicate simultaneously thanks to the communication system 10, while moving about. The simultaneous use of multiple communication terminals is not limited to the embodiment illustrated in FIG. 5. It is also possible with the other embodiments, in particular those described previously with reference to FIG. 3 or 4.

Although not necessarily, as represented in FIGS. 3, 4 and 5, the communication system 10 may further comprise a control device 20 and an audio device conventionally incorporated in the cockpit 3 of the aircraft. The control device 20, e.g. of the ACP type, is conventionally connected to the communication computer 12 via a wired link 21. The audio device includes, for example, a microphone 22a and a loudspeaker 22b conventionally connected to the communication computer 12 via a wired link 24a and via a wired link 24b, respectively. This control device and this audio device are usable by a pilot in the cockpit of the aircraft. Communications on the different communication channels may then be controlled and implemented just as well by the communication terminal 35 as by the control device 20 and the audio device incorporated in the cockpit.

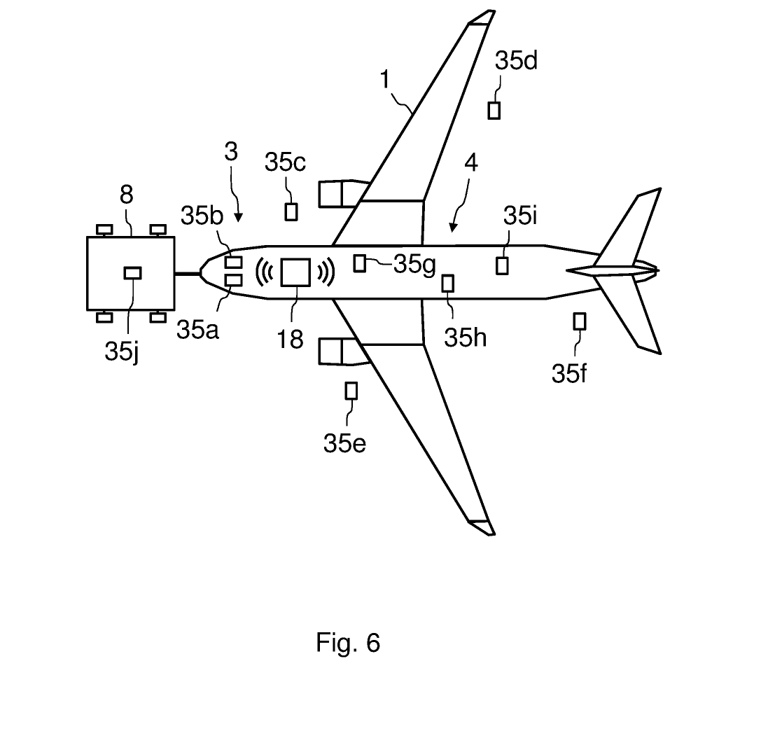

In the example represented in FIG. 6, the aircraft 1 comprises a communication system 10 such as that previously described. For clarity in the figure, only the communication unit 18 is represented. The communication system 10 is configured so as to allow multiple users to use portable communication terminals, respectively referenced 35a, 35b . . . 35j, similar to the communication terminal 35 already described. Different applications of the communication terminals are illustrated in the figure, even if these applications are not necessarily implemented simultaneously. The communication terminal 35a is used by a pilot of the aircraft, just as well in the cockpit 3 as outside the cockpit, when the pilot moves about in the aircraft. The pilot may thus move about in the aircraft while retaining the same communication functionalities as in the cockpit. When the pilot uses this communication device in the cockpit, they preferably leave it placed on a base for recharging a battery thereon. The pilot may use the communication terminal just as well when the aircraft is on the ground as when it is in flight. Similarly, a copilot of the aircraft in his/her turn has a communication terminal 35b. When the aircraft is on the ground, maintenance operators responsible for intervening on this aircraft have portable communication devices 35c, 35d, 35e . . . 35f. These communication terminals allow them to communicate on different communication channels with a pilot of the aircraft, with the airline company, etc. while moving about in or around the aircraft. During the testing of the aircraft, in particular during flight tests, personnel taking part in these tests, e.g. in the passenger cabin 4 of the aircraft, are provided with communication terminals 35g, 35h . . . 35i. They may use these communication terminals for selecting a communication channel and for communicating, for example, with a pilot of the aircraft or with a flight test centre based at the aircraft manufacturer. In this last case, communications may take place on a communication channel dedicated to telemetry. When the aircraft is in taxiing phases on an airport surface, the aircraft is sometimes towed by a tractor 8. A driver of the tractor is provided with a communication terminal 35j enabling them notably to communicate with a pilot of the aircraft or with the air traffic control in charge of the airport.

Advantageously, according to the physical location of the communication unit 18 in the aircraft and the areas in which users are likely to use portable communication terminals 35, the communication system may further include one or more remote aerials connected to the communication unit 18, e.g. by means of coaxial cable.

Although the different embodiments of the invention have been described on the basis of DECT type wireless links, other types of wireless links are conceivable without departing from the scope of the invention. In particular, wireless links of the WAIC (“Wireless Avionics Intra Communications”) type may be implemented. Wireless communications of the WAIC type take place in the frequency band 4200-4400 MHz dedicated to aviation. The wireless communication links between the wireless communication unit 18, the communication terminals 35, 35a . . . 35j and where necessary the communication computer 12 may, for example, be implemented by using the DECT type principle and protocols in said frequency band. This then makes it possible to benefit from the advantages of DECT type links, in particular their reliability and availability, by using said frequency band dedicated to aviation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A communication system of an aircraft, the communication system comprising:
a set of communication channels;
a communication computer;
an audio device;
a control device connected to the communication computer;
a wireless communication unit interfaced to the communication computer, the wireless communication unit configured for simultaneously implementing:
a two-way wireless audio link between the wireless communication unit and the audio device, so as to allow an audio communication on one of the communication channels by the audio device; and
a two-way wireless data link between the wireless communication unit and the control device, allowing the control device to control the communication computer.

2. The system according to claim 1, wherein the audio device and the control device are incorporated in a portable device and the wireless audio link and the wireless data link are supported by a single wireless link between the wireless communication unit and the portable device.

3. The system according to claim 2, wherein the single wireless link is of the DECT type.

4. The system according to claim 2, wherein the single wireless link is of the WAIC type.

5. The system according to claim 1, wherein the wireless communication unit is incorporated in the communication computer.

6. The system according to claim 2, wherein the communication computer comprises a wireless communication interface and the wireless communication unit is connected to the communication computer via a single wireless link supporting a two-way wireless audio link and a two-way wireless data link.

7. The system according to claim 6, wherein the wireless communication unit implements the wireless link between the communication computer and said wireless communication unit, and the wireless link between the portable device and said wireless communication unit by the same wireless communication interface.

8. The system according to claim 6, wherein the wireless communication unit is located in the passenger cabin of the aircraft.

9. The system according to claim 1, further comprising a second control device connected to the communication computer via a wired link.

10. An aircraft comprising a communication system according to one of claim 1.
